(19) United States
(12) Patent Application Publication
(10) Pub. No.: US 2007/0038814 A1
(43) Pub. Date: Feb. 15, 2007

(54) Systems and methods for selectively inclusive cache

(75) Inventors: James Norris Dieffenderfer, Apex, NC (US); Praveen G. Karandikar, Cary, NC (US); Michael Bryan Mitchell, Fuquay-Varina, NC (US); Thomas Philip Speier, Holly Springs, NC (US); Paul Michael Steinmetz, Morrisville, NC (US)

Correspondence Address: IBM COPORATION (RTP);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 11/201,221

(22) Filed: Aug. 10, 2005

(51) Int. Cl. G06F 13/28

(52) U.S. Cl. 711/141; 711/146

(57) ABSTRACT

Embodiments include systems and methods for selectively inclusive multi-level cache. When data for which memory coherency is designated is received from a process and stored into a lower level cache the data is copied into a higher level of cache. When the data is snooped it is snooped from the higher level cache and not the lower level of cache. When data is invalidated in the higher level cache, the data is invalidated in the lower level cache also. Lines of higher level cache are inclusive of lower level cache lines for data for which memory coherency is designated, but need not be inclusive of data for which coherency is not designated.

### FIELD

The present invention is in the field of digital processing. More particularly, the invention is in the field of multi-level cache inclusiveness.

### BACKGROUND

Many different types of computing systems have attained widespread use around the world. These computing systems include personal computers, servers, mainframes and a wide variety of stand-alone and embedded computing devices. Sprawling client-server systems exist, with applications and information spread across many PC networks, mainframes and minicomputers. In a distributed system connected by networks, a user may access many application programs, databases, network systems, operating systems and mainframe applications. Computers provide individuals and businesses with a host of software applications including word processing, spreadsheet, accounting, e-mail, voice over Internet protocol telecommunications, and facsimile.

Users of digital processors such as computers continue to demand greater and greater performance from such systems for handling increasingly complex and difficult tasks. In addition, processing speed has increased much more quickly than that of main memory accesses. As a result, cache memories, or caches, are used in such systems to increase performance in a relatively cost-effective manner. At present, every general purpose computer, from servers to low-power embedded processors, includes at least a first level cache L1 and typically a second level cache L2. This dual cache memory system enables storing frequently accessed data and instructions close to the execution units of the processor to minimize the time required to transmit data to and from memory. L1 cache is typically on the same chip as the execution units. L2 cache may be on the same chip as the processor core or external to the processor chip but physically close to it. Accessing the L1 cache is faster than accessing the more distant system memory. Ideally, as the time for execution of an instruction nears, instructions and data are moved to the L2 cache from a more distant memory. When the time for executing the instruction is near imminent, the instruction and its data, if any, is advanced to the L1 cache. Moreover, instructions that are repeatedly executed may be stored in the L1 cache for a long duration. This reduces the occurrence of long latency system memory accesses.

As the processor operates in response to a clock, an instruction fetcher accesses data and instructions from the L1 cache and controls the transfer of instructions from more distant memory to the L1 cache. A cache miss occurs if the data or instructions sought are not in the cache when needed. The processor would then seek the data or instructions in the L2 cache. A cache miss may occur at this level as well. The processor would then seek the data or instructions from other memory located further away. Thus, each time a memory reference occurs which is not present within the first level of cache, the processor attempts to obtain that memory reference from a second or higher level of memory.

The L1 cache of a processor stores copies of recently executed, and soon-to-be-executed, instructions, and also stores data generated by the processor and data retrieved from a more distant memory. Data and instructions are obtained from “memory lines” of system memory. A memory line is a unit of system memory from which data to be stored in the cache is obtained. A cache line is a subset of a memory line. The address or index of a cache entry may be determined from the lower order bits of the system memory address of the cache line to be stored at that entry. Multiple system memory addresses therefore map into the same cache index. The higher order bits of the system memory address form a tag. The tag is stored with the instruction in the cache entry corresponding to the lower order bits. The tag uniquely identifies the instruction with which it is stored.

Advances in silicon densities allow for the integration of numerous functions onto a single silicon chip. With this increased density, peripheral devices formerly attached to a processor at the card level are integrated onto the same die as the processor. This type of implementation of a complex circuit on a single die is referred to as a system-on-a-chip (SOC). With a proliferation of highly integrated system-on-a-chip designs, the shared bus architecture that allows major functional units to communicate is commonly utilized. There are many different shared bus designs which fit into a few distinct topographies. A known approach in shared bus topography is for multiple masters—such as multiple processors—to present requests to an arbiter of the shared bus for accessing an address range of an address space. The address space may be of a slave device such as a common system memory unit. Thus, one such type of slave device is a system memory, external to the processors' cache. The arbiter awards bus control to the highest priority request based on a request prioritization algorithm. As an example, a shared bus may include a Processor Local Bus that may be part of a CoreConnect bus architecture of International Business Machines Corporation (IBM).

Thus, a system-on-a-chip or Ultra Large Scale Integration (ULSI) design, typically comprises multiple masters—for example, processors—and slave devices—for example, system memory—connected through the Processor Local Bus (PLB). The PLB consists of a PLB core (arbiter, control and gating logic) to which masters and slaves are attached. A master can perform read and write operations at the same time in an address-pipelined architecture, because the PLB architecture has separate read and write buses.

In a typical architecture that includes a PLB, each master is in electrical communication with the PLB core via at least one dedicated port or line. The multiple slaves in turn, are connected to the PLB core via a PLB shared data bus and a command bus allowing each master to communicate with each slave connected to the PLB shared data bus and the command bus. Each slave has an address, which allows a master to select and communicate with a particular slave among the plurality of slaves. When a master wants to communicate with the particular slave, the master sends certain information to the PLB core for distribution to the slaves. An example of this information is the selected bus command, the write_data command and the address of the slave.

Complications can arise when the data at an address in system memory is not as up-to-date as data in a processor's cache. Consider a situation where a first processor issues a request to read a value from memory. It may occur that a second processor has internally updated that value and stored the updated value in its internal cache. This renders the value in memory old and therefore invalid. A read request is snoopable if the requested item should be received from the processor with the most up-to-date value. When the first processor issues a request to read a value in system memory, the PLB issues a snoop request to each of the other processors in the SOC to determine if another processor has a more up-to-date value of the requested item. If so, the PLB seeks the data from the processor that has the up-to-date value. Conventionally, the updated value from the second processor is transferred to the first processor in two steps: first, the updated value from the second processor is copied to system memory. Then the valued is copied from system memory to the internal cache of the first processor.

A further complication arises when a processor comprises a multi-level cache structure. When a processor receives a snoopable request from the PLB, it may first look into its higher level cache. In an inclusive system, a copy of a lower level cache is stored in the next higher level of cache. But, in a non-inclusive system, the snooped item may not be in the higher level cache, but rather, in a lower level cache. The system would then look in the next lower cache level for the snooped item. To avoid the latency and processing cycles associated with this lower level reach into memory, one may implement an inclusive system. In an inclusive system, one need only address the higher level cache, because it contains a copy of the lower level cache. Disadvantageously, however, a fully inclusive system consumes memory, since an entire copy of the lower level cache is contained in the higher level cache. What is needed is a selectively inclusive shared-cache system so that not the entire volume of the lower level cache need be stored in the higher level cache to avoid lower level cache snoops.

### SUMMARY

The problems identified above are in large part addressed by systems and methods for selectively inclusive multi-level cache. Embodiments implement a multi-level cache system, comprising at least a lower level cache memory and a higher level cache memory. A coherency determiner determines from a memory coherency attribute if coherency is designated for an item of data in the lower level cache. A cache controller copies the item of data from the lower level cache to the higher level cache if coherency is designated for the item of data.

In one embodiment, a multi-level cache system comprises a plurality of processors. Each processor comprises execution units and a lower level of cache and a higher level of cache. A system memory is commonly shared by a plurality of the processors. A processor local bus comprises circuitry to enable transfer of data between a plurality of the processors and the system memory. A coherency determiner determines whether coherency is designated for an item of data stored in the lower level of cache. A cache control mechanism copies an item of data from the lower level of cache to the higher level of cache if memory coherency is designated for the item of data. The cache control mechanism bypasses the step of copying the item of data from the lower level cache to the higher level cache if memory coherency is not designated for the item of data. Embodiments may further comprise a validity checking mechanism to determine in response to a snoop request whether requested data is held in a modified state in a highest level of cache. Embodiments may further comprise a validation control mechanism to invalidate data in the lower level cache in response to a signal from a control mechanism of the higher level cache.

Another embodiment is a method for allocating memory in a multi-level-cache system. The method comprises determining from a user-specified attribute associated with an item of data in a first, lower level of cache that memory coherency is designated for the item of data. The method further comprises copying the item of data from the first cache to a second, higher level of cache if memory coherency is designated for the item of data; and bypassing a step of copying the item of data from the first cache to the second cache if memory coherency is not designated for the item of data. The method may further comprise detecting a condition wherein the item of data copied to the higher level cache is invalid; and invalidating the item of data in the first, lower level of cache; in response to the detected condition.

### BRIEF DESCRIPTION OF THE DRAWINGS

Other objects and advantages of the invention will become apparent upon reading the following detailed description and upon reference to the accompanying drawings in which, like references may indicate similar elements:

FIG. 1 depicts a digital system within a network; within the digital system is a digital processor.

FIG. 2 depicts an integrated device with a processor local bus core and with multiple digital processors having multiple levels of cache.

FIG. 3 depicts a more a more detailed view of an embodiment of a processor local bus.

FIG. 4 depicts a more detailed view of a multi-level cache control in a processor.

FIG. 5 depicts a flow chart of an embodiment for handling snoop requests and invalidation commands.

FIG. 6 depicts a flow chart of an embodiment for copying data from a lower level cache to a higher level of cache if memory coherency is designated for the data.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Embodiments include systems and methods for selectively inclusive multi-level cache. When data for which memory coherency is designated is received from a process and stored into a lower level cache the data is copied into a higher level of cache. When the data is snooped it is snooped from the higher level cache and not the lower level of cache. When data is invalidated in the higher level cache, the data is invalidated in the lower level cache also. Lines of higher level cache are inclusive of lower level cache lines for data for which memory coherency is designated and need not be inclusive for data not coherency-designated.

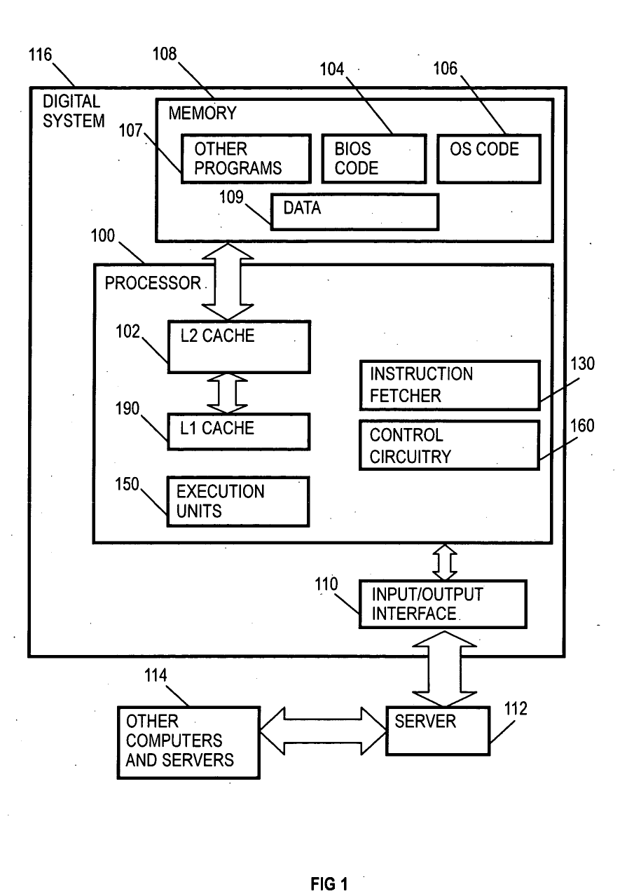

FIG. 1 shows a digital system 116 such as a computer or server implemented according to one embodiment of the present invention. Digital system 116 comprises a processor 100 that can operate according to (Basic Input-Output System) BIOS Code 104 and Operating System (OS) Code 106. The BIOS and OS code is stored in memory 108. The BIOS code is typically stored on Read-Only Memory (ROM) and the OS code is typically stored on the hard drive of computer system 116. Thus, memory 108 is comprised of multiple storage mechanisms. Memory 108 also stores other programs for execution by processor 100 and stores data 109.

Processor 100 comprises a level 2 (L2) cache 102, level 1 (L1) cache 190, an instruction fetcher 130, control circuitry 160, and execution units 150. Level 1 cache 190 receives and stores instructions that are near to time of execution. Instruction fetcher 130 causes instructions to be loaded into L1 cache 190 from system memory 108 external to the processor. L1 loads instructions from L2 cache, which loads the instructions from system memory. Instruction fetcher 130 also receives instructions from L1 cache 190 and sends them to execution units 150. Execution units 150 perform the operations called for by the instructions. Execution units 150 may comprise load/store units, integer Arithmetic/Logic Units, floating point Arithmetic/Logic Units, and Graphical Logic Units. Each execution unit comprises stages to perform steps in the execution of the instructions received from instruction fetcher 130. Control circuitry 160 controls instruction fetcher 130 and execution units 150. Control circuitry 160 also receives information relevant to control decisions from execution units 150. For example, control circuitry 160 is notified in the event of a data cache miss in the execution pipeline.

Digital system 116 also typically includes other components and subsystems not shown, such as: a Trusted Platform Module, memory controllers random access memory (RAM), peripheral drivers, a system monitor, a keyboard, one or more flexible diskette drives, one or more removable non-volatile media drives such as a fixed disk hard drive, CD and DVD drives, a pointing device such as a mouse, and a network interface adapter, etc. Digital systems 116 may include personal computers, workstations, servers, mainframe computers, notebook or laptop computers, desktop computers, or the like. Processor 100 may also communicate with a server 112 by way of Input/Output Device 110. Server 112 connects system 116 with other computers and servers 114. Thus, digital system 116 may be in a network of computers such as the Internet and/or a local intranet. Also, components of digital system 116 may be implemented as part of a system on a chip that includes a processor local bus.

In one mode of operation of digital system 116, the L2 cache receives from a higher level memory 108 data and instructions expected to be processed in the processor pipeline of processor 100. The L2 cache 102 receives from memory 108 the instructions for a plurality of instruction threads. Such instructions may include branch instructions. The L1 cache 190 contains data and instructions preferably received from L2 cache 102. Ideally, as the time approaches for a program instruction to be executed, the instruction is passed with its data, if any, first to the L2 cache, and then as execution time is near imminent, to the L1 cache.

Execution units 150 execute the instructions received from the L1 cache 190. Execution units 150 may comprise load/store units, integer Arithmetic/Logic Units, floating point Arithmetic/Logic Units, and Graphical Logic Units. Each of the units may be adapted to execute a specific set of instructions. Instructions can be submitted to different execution units for execution in parallel. Data processed by execution units 150 are storable in and accessible from integer register files and floating point register files (not shown.) Data stored in these register files can also come from or be transferred to on-board L1 cache 190 or L2 cache 102 or external cache or memory. The processor can load data from memory, such as L1 cache, to a register of the processor by executing a load instruction. The processor can store data into memory from a register by executing a store instruction. Persons of skill in the art will understand that L2 cache 102 and/or L1 cache 190 may be external to processor 100.

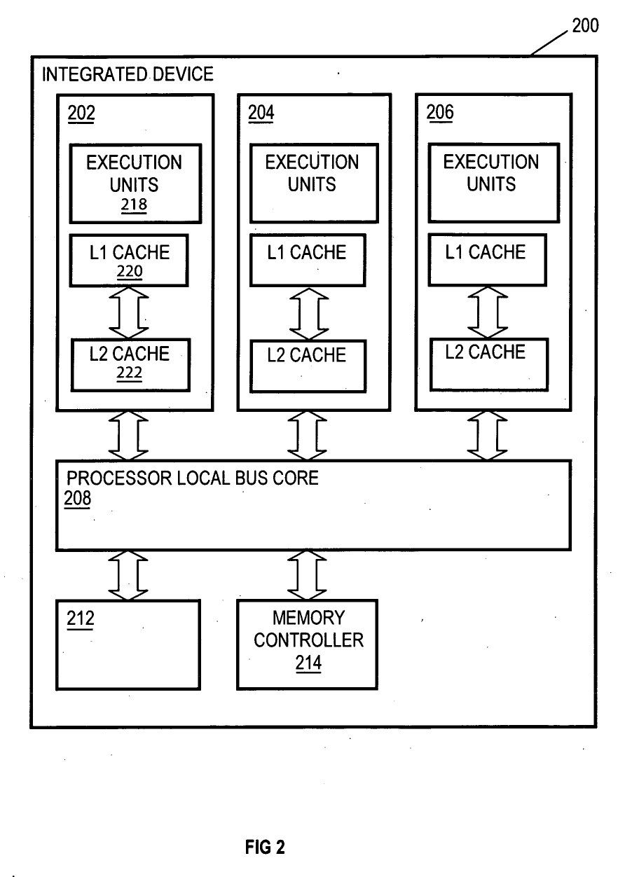

FIG. 2 depicts a typical system-on-a-chip (SOC) integrated device, generally denoted 200, having a plurality of internal functional masters 202, 204, 206. Each master may be a processor, as described above with respect to processor 100, with cache memory 220 and 222 and execution units 218. The masters connect to a processor local bus (PLB) core 208 with logic and circuitry for controlling transfers of data between masters and slaves 212 and 214. A slave may be a memory system such as a memory system 214 with a memory controller (not shown). Other slaves may include a memory system that is external to integrated device 100. Masters may read data from a slave and write data to a slave through the PLB, under the control of PLB core 208. Thus, the PLB core contains circuitry to arbitrate read and write requests and facilitate data transfer between master and slave.

A master may be a processor, memory controller or other device. For example processor 202 may comprise execution units 218, level 1 (L1) cache 220, and level 2 (L2) cache 222, as well as other elements not shown such as an instruction fetcher, instruction buffer, dispatch unit, etc. Note that although only two levels of cache are shown for a processor, a processor may comprise more than two levels of cache. The principles of the invention set forth herein are applicable to a hierarchy of two or more levels of cache. An embodiment provides selective inclusiveness, whereby selective lines of data in a higher level cache are copied from corresponding lines of data in a next lower level of cache so that the lower levels of cache need not be snooped.

In operation, the instruction fetcher of the processor obtains instructions to be executed from system memory 214 and stores the instructions in its L2 and L1 cache. Thus, as instructions are needed for execution, they are transferred from system memory 214 to L2 cache 222. As the time for execution of a group of instructions draws near, the instruction fetcher transfers the instructions to L1 cache 220. The instruction fetcher executes a mapping function to map “real addresses” to an address in the cache. A real instruction address is the address within system memory 214 where an instruction is stored. Thus, a real address of a memory location in system memory maps into an L2 cache address. Since L2 cache is typically smaller than system memory, multiple system memory addresses will map into a single L2 cache address. Similarly, an L2 cache address maps into an L1 cache address and multiple L2 addresses will map into an L1 cache address. The time required for the processor to access data and instructions from a lower level memory, such as L1 cache 220, is much less than the time required for the processor to access data and instructions from a higher level memory, such as L2 cache 222. Conversely, the time required to retrieve data from a lower level cache in response to a snoop request is greater than the time required to retrieve data from a higher level cache in response to a snoop request.

Integrated circuit 200 may comprise a plurality of processors including the just-listed elements and each processor may place read and write requests on the PLB. PLB core 208 coordinates requests to the slaves in the integrated device. For example, slave 212 may comprise an external bus controller which is connected to an external non-volatile memory, such as flash memory. Slave 212 may be a memory controller that connects to external or internal volatile memory, such as SDRAM or DRAM. In general, functional masters 202-206 share a common memory pool 214 in this integrated design in order to minimize memory costs, and to facilitate the transfer of data between the masters. As such, all internal masters may have equal access to both non-volatile and volatile memory. Non-volatile memory is used for persistent storage for when data should be retained even when power is removed. This memory may contain the boot code, operating code, such as the operating system and drivers, and any persistent data structures. Volatile memory is used for session oriented storage, and generally contains application data as well as data structures of other masters. Since volatile memory is faster than non-volatile memory, it is common to move operating code to volatile memory and execute instructions from there when the integrated device is operational.

As shown in the example of FIG. 2, a plurality of processors, each having its own cache memory and execution units, may communicate with each other and the slaves through the PLB. To transfer data from a cache to system memory 214, a processor 202 issues a write request to PLB core 208 and places the data to be transferred on the PLB. PLB core 208 will execute the transfer of the data in response to the request. The request identifies memory system 214 as the slave to receive the data. The request also contains the address in memory system 214 where the data is to be stored. A memory controller of memory system 214 causes the memory to be addressed and causes the data received from the PLB to be written to memory at the specified address.

To transfer data from memory 214 to a processor's cache, the processor issues a read request to PLB core 208. The request identifies memory system 214 as the slave to provide the data. The request also contains the address in memory system 214 from where the data is retrieved. The memory controller of memory system 214 causes the memory to be addressed and causes the data at the address to be written to the PLB. The PLB then transfers this data to the processor that issued the write request.

Complications can arise when the data at an address in system memory is not as up-to-date as data in a processor's cache. Consider a situation where a first processor 202 issues a request to read a value from memory 214. It may occur that a second processor 204 has internally updated that value and stored the updated value in its internal cache, either L1 or L2. This renders the value in memory 214 old and therefore invalid. Desirably, a mechanism is provided to detect when this occurs and to then copy the updated value from the internal cache of the second processor 204 to the internal cache of the first processor 202, and to the memory 214. In this way, the system preserves memory coherency.

Conventionally, the updated value from the second processor is transferred to the first processor in two steps: first, the updated value from the second processor is copied to memory 214. Then the valued is copied from memory 214 to the internal cache of the first processor. Or consider the situation when the first processor issues a write request to write a data value to memory 214 but a second processor has a more up-to-date version of the data value. Embodiments may detect this condition as well and cause the updated value from the second processor, instead of the old value from the first processor, to be written to memory 214.

Thus, a first processor 204 may request data that is held in a modified state in a cache of a second processor 202. To achieve memory coherency for the requested data, the first processor must receive the modified data held by the second processor. When the request of the first processor 204 is received by the PLB, a snoop request is sent to the L2 cache 222 of the second processor 202. In a non-inclusive system, the system would first inspect L2 cache 222 to determine if the data there is the most recently modified, and would then look to the L1 cache 220 to determine if the data in L1 is most recently modified. In a wholly inclusive system, a copy of the contents of L1 cache 220 is kept in L2 cache 222. Therefore, the system snoops L2 but not L1. Thus, in a wholly inclusive system, cycles of processor operation are not taken away to check the L1 cache. However, the wholly inclusive system consumes memory out of L2 since L2 must have a copy of the entire L1 cache. For example, if the L1 cache is 32 kilo-bytes (kb) and the L2 cache is 256 kb, 32 kb of the L2 cache is devoted to storing a copy of L1. Thus, embodiments provide selectively inclusive cache to conserve memory resources.

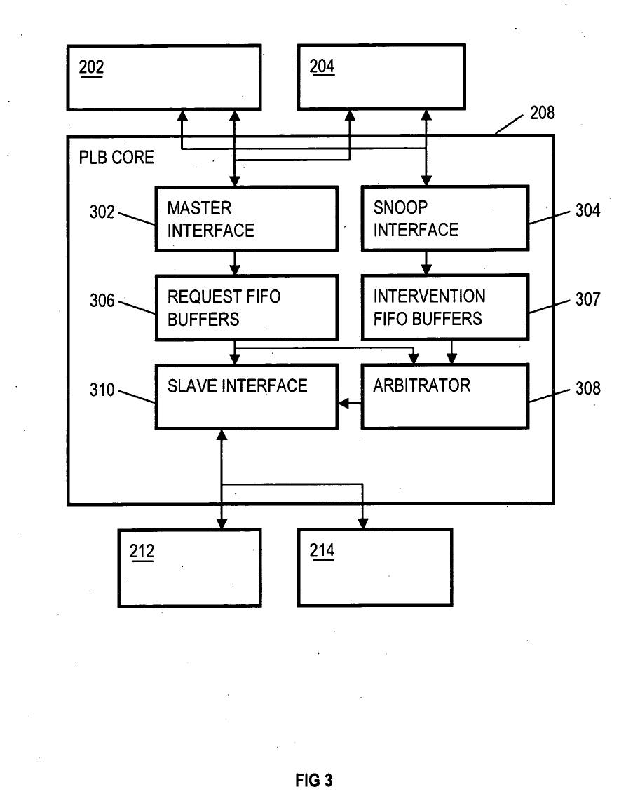

FIG. 3 shows an embodiment of a PLB core 208 to enable multiple functional masters 202, 204 to communicate with multiple slaves 212, 214 over a shared bus. An example of this bus architecture is the Processor Local Bus (PLB) of the CoreConnect architecture marketed by International Business Machines Corporation of Armonk, N.Y. The masters within the architecture each have a unique master id (identification) which comprises part of the request signal that is sent to an arbitrator 308 of PLB core 208. When multiple requests are presented, arbitrator 308 selects which request to process next according to a priority scheme, and sends an acknowledgment signal to the master that issued the selected request.

Arbitrator 308 also propagates the granted request to the slaves through a slave interface 310, along with the additional information needed, i.e., data address information and control information. As one example, the control information might include a read/write control signal which tells whether data is to be written from the master to the slave or read from the slave to the master. The data address signals pass through a first multiplexer (not shown), while the control signals pass through a second multiplexer (also not shown). Similarly, data to be written passes from the masters to the slaves through a multiplexer, and data read via the slaves returns to the masters through a multiplexer within PLB core 208. Further, a multiplexer multiplexes control signals from the slaves for return to the masters. These control signals may include, for example, status and/or acknowledgment signals. Conventionally, the slave to which a granted master request is targeted based on the address, responds to the master with the appropriate information. The multiplexers are controlled by arbitrator 308.

Thus, each of a plurality of masters, hereafter also referred to as processors, (although not limited to processors), can read data from a slave comprising a memory 214, or write data to the memory 214. PLB core 208 comprises a master interface 302. Master interface 302 receives requests from the processors and sends information, such as acknowledgment signals, to the processors. For example, a master may transmit a write request with data to be written to a slave, along with the identification of the slave to which the data is to be written and the slave address where the data is to be written within the slave. Or, a master may send a read request, along with the identification of the slave from which the data is to be obtained along with the address from where to obtain the data. In one example, the slave is a system memory accessible by a slave interface 310 of PLB core 208. The slave interface sends data to the system memory 214 or to slave 212 and receives data from the memory 214 or from slave 212.

Each request comprises certain qualifiers that characterize the request: whether the request is to read or write, whether the request is snoopable (to be explained subsequently), the slave ID, the master ID, etc. Each request from a processor 202, 204 is received by way of the master interface 302 and placed in a First-In-First-Out (FIFO) request buffer 306 corresponding to the processor making the request. Thus, associated with each processor is a particular one of a plurality of FIFO request buffers 306. These requests are handled in an order determined by arbitrator 308 according to a priority scheme. For example, requests from a first processor may have priority over requests from a second processor. Requests may also be prioritized according to type of request, such as whether the request is snoopable. For example, non-snoopable requests may receive priority over snoopable requests.

A snoopable request is a request to read or write data from a slave device that is broadcast to one or more snoopable devices. A snoopable device is one that can determine whether it holds in its cache the requested data in a modified state. A snoopable device is connected to a snoop interface 304 to enable transfer of data in a modified state from the snoopable device to the PLB. In some embodiments, not all devices are snoopable and therefore need not be connected to the snoop interface. Similarly, not all requests are snoopable requests and, hence, are not broadcast through the snoop interface. But when a snoopable request is received, it is broadcast through the snoop interface to the snoopable devices connected thereto. Each snoopable device will, in response to the broadcast request, determine if it holds the requested data in modified state. When memory coherency is required, only one processor can hold the data in modified state. The processor that holds the data in modified state, if any, notifies the PLB core, which then receives the requested data in modified state.

When a processor submits a request to the PLB, the request is placed in a FIFO buffer 306 for that processor. The request comprises a qualifier that indicates whether the request is snoopable. The request is handled in its turn by arbitrator 308. If the request is not snoopable, then the request is not broadcast to the snoopable processors, but rather, the request is handled by transferring the data that is the subject of the request directly to or from the requested slave through the PLB. If the request is snoopable, then the request is broadcast to the snoopable processors by way of snoop interface 304.

When a snoopable processor receives a snoopable request through snoop interface 304, the processor receives the memory address of memory 214 that was provided by the processor that initiated the request. This memory address corresponds to a memory location in the processor's cache according to a mapping function that maps the addresses of memory 214 to processor cache addresses. The processor determines from an attribute—tag—of the data at the specified address whether the data is in modified state. Only one processor may have an updated value for the requested data. If the processor determines that its cache entry is in modified state, then the processor signals through the snoop interface to the PLB core 208 that an updated value exists in its cache. The processor then writes the updated value, hereafter referred to as the “castout” data, to PLB core 208 by way of snoop interface 304. The process of sending the castout data to the PLB core to be transferred to memory and to the requesting master is called a castout.

Two types of snoopable requests can result in a castout. One is a snoop flush and the other is a snoop push. When a snoop flush is received, the processor marks the snooped data in the L2 cache as invalid. When a snoop push occurs, the processor does not mark the snooped data as invalid. A third type of snoop request—called a snoop kill—does not result in a castout. Rather, the data in the L2 cache is merely invalidated.

When a castout occurs, the castout data is written to a FIFO buffer 307 corresponding to the processor from which the castout data is obtained. Thus, PLB core 208 comprises two sets of FIFO buffers: (1) the FIFO buffers 306, one for each processor, that receive requests from the processors, and (2) the FIFO buffers 307, one for each snoopable processor, that receives castout data from the processor caches. Herein, the first set of buffers may be referred to as request buffers, and the second set of buffers may be referred to as intervention buffers.

Thus, each line or unit of data has associated therewith, an attribute that indicates whether the data is invalid or modified. Each line or unit of data in a cache also has associated there with, an attribute that indicates whether memory coherency for the data is required. Only one processor is privileged to hold the data in its cache in modified state at a time. All other processors can only hold the data in the invalid state. Each line of data in a cache also has associated there with, a write-through attribute which, if selected, causes the data to be written through to the next higher level of cache if there is one.

When a processor 202 receives a snoop request from snoop interface 304, the processor 202 looks into its higher level cache for the data in modified state. Embodiments provide selective inclusiveness so that a processor needs to look in the highest level cache in response to the snoop request but does not need to look in a lower level cache. First, note that if the data held in the higher level cache is invalid, there is no reason to snoop the processor further, because the snoop request seeks the data from the processor that holds it in modified state. As will be seen, when the line of data in the higher level of cache is invalidated, the corresponding line in the next lower level of cache is also invalidated. Second, note that if the data in the higher level of cache is held in the modified state, there is no reason to snoop a lower level of cache because the line in the higher level cache is a copy of the corresponding data in the next lower level of cache.

Note in particular that only data for which memory coherency is required need be copied into the higher level of cache from the lower level. Thus, embodiments provide a selectively inclusive system for allocating data storage between a first level cache, close to the processor core, and a second, higher level, cache more distant from the processor core. The principles of operation of embodiments will be described primarily with reference to two levels of cache although the principles extend to more than two levels of cache.

As noted, data held in cache has associated there with a collection of attributes. These attributes include a write-through attribute, and a coherency attribute. The write-through attribute, if selected, causes modified data in the lower level cache, L1, to be written through to the higher level cache, L2. The coherency attribute indicates whether memory coherency is required for the modified data. The system designer may designate, on a line-by-line basis, which cache lines of L1 are written through to L2, and which cache lines require memory coherency. If a cache line of L1 is designated as write-through, the cache line is written through to L2. Also, written to L2 is whether memory coherency is required for the data of the cache line. Since only the lines for which memory coherency is required need be copied from the lower level cache to the higher level cache, and because a user may select for which data memory coherency is required, the higher level cache is selectively inclusive of lines in the lower level cache.

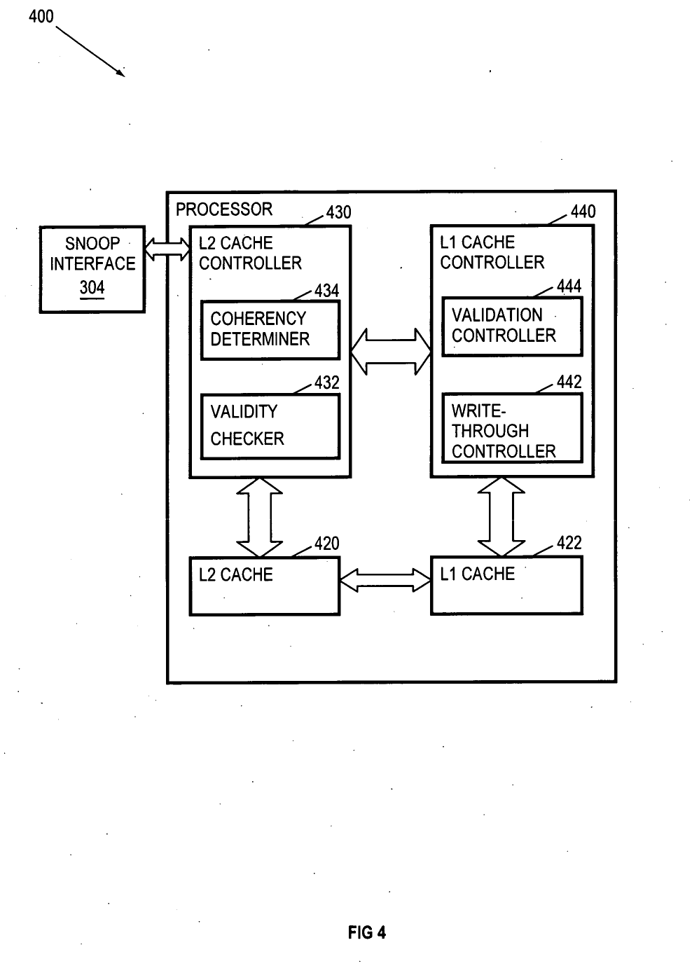

FIG. 4 shows a processor 400 with an L1 cache 420 and an L1 cache controller 430. Processor 400 also comprises an L2 cache 422 and L2 cache controller 440. When, for example, the processor transfers a value from its register to L1 cache 420, this data is written through to L2 cache 422 if the data is designated as write-through data. Data will be designated as write-through if memory coherency is designated for the data. A write controller 442 of L2 cache controller 440 determines from the write-through attribute of an item of data whether the data is to be written through from L1 to L2. If the data is write-through, the system transfers a copy of the data to the L2 cache along with its memory coherency attribute. If the system is operating in a selectively inclusive mode, a coherency determiner 434 of L2 cache controller 430 determines if coherency is designated for the item of data copied from L1.

When a snoop request from snoop interface 304 is received by the L2 cache controller 440 for the written-through data requiring memory coherency, the L1 cache is not, and need not be, snooped. Rather, a validity checker 432 determines if the data in L2 is held in modified state, and if so, the modified data is obtained from L2 and copied to snoop interface 304. Conversely, the processor 400 may issue a read request for snoopable data. In response, the processor receives updated data from system memory or from another processor's cache. The processor writes the updated data to L2 cache 422 of processor 400. The processor may also write this data through to L1 cache 420.

Further, in response to a snoop flush or snoop kill, data in the L2 cache may be marked as invalid or replaced. For example, the system may overwrite data in a cache line of L2 with new data. Coherency may or may not be required for the new data. This new data may be from an external source such as system memory. When this occurs, L2 cache controller 440 issues an invalidate command to a validation controller 444 of L1 cache controller 430. In response, validation controller 444 changes an attribute of the line of data in L1 that corresponded to the overwritten data in L2 from valid to invalid.

As another example, L2 cache controller 440 may receive from the snoop interface 304 a command to invalidate a line of data in L2. This may occur, for example, if another processor becomes the processor privileged to hold the data in modified state. When this occurs, cache controller 440 issues an invalidate command to validation controller 444 of L1 cache controller 430. In response, validation controller 444 changes the modified/invalid attribute of the line of data in L1 that corresponded to the invalidated data in L2 to invalid. Note that typically there are many more cache lines in L2 than L1, and each cache line in L2 is longer than a cache line in L1. Thus, one line in L2 may hold 4 lines of L1. Thus, if an entire cache line of L2 is invalidated, then validation controller 444 must invalidate four lines in L1.

Thus, embodiments provide a selectively inclusive higher level cache. When operating in a selectively inclusive mode, the higher level cache includes a copy of those lines in the lower level cache for which memory coherence is required and does not keep inclusive lines for which memory coherence is not required. For coherency-designated lines, snooping the higher level cache is sufficient and snooping of the lower level cache is not necessary. The system programmer can therefore configure cache memory by specifying the write-through and coherency attributes of an item of data.

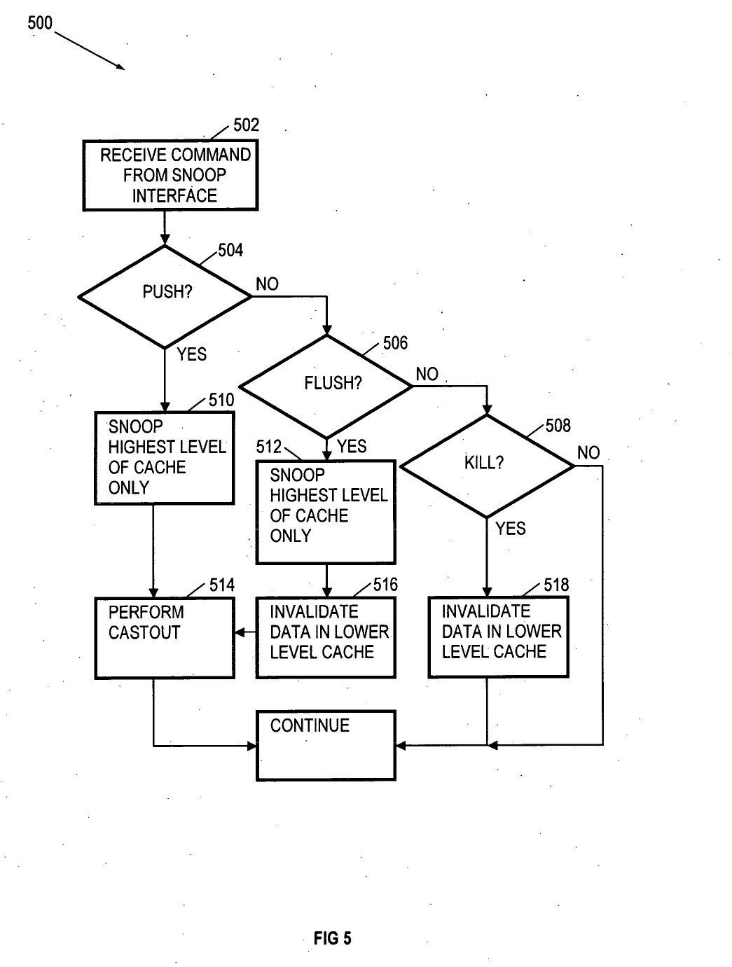

FIG. 5 shows a flow chart 500 of operation of an embodiment for responding to snoop commands from a snoop interface (element 502). As shown, three commands that can be received from the snoop interface are a snoop push (element 504), a snoop flush (element 506) and snoop kill (element 510). If the processor receives a snoop push (element 504), then the embodiment snoops the highest level of cache (element 510) without snooping a lower level of cache. If the highest level of cache holds the snooped data, the cache performs a castout to the snoop interface (element 514). If a snoop flush is received (element 506), then the embodiment snoops the highest level of cache (element 512) without snooping a lower level of cache. If the embodiment holds the snooped data, the data in the highest level cache is invalidated and the data in the lower level of cache is invalidated (element 516). Also, the embodiment performs a castout (element 514). When the system receives a snoop kill, the system invalidates the data in the highest level cache and invalidates the data in the lower level cache (element 518), No castout is performed.

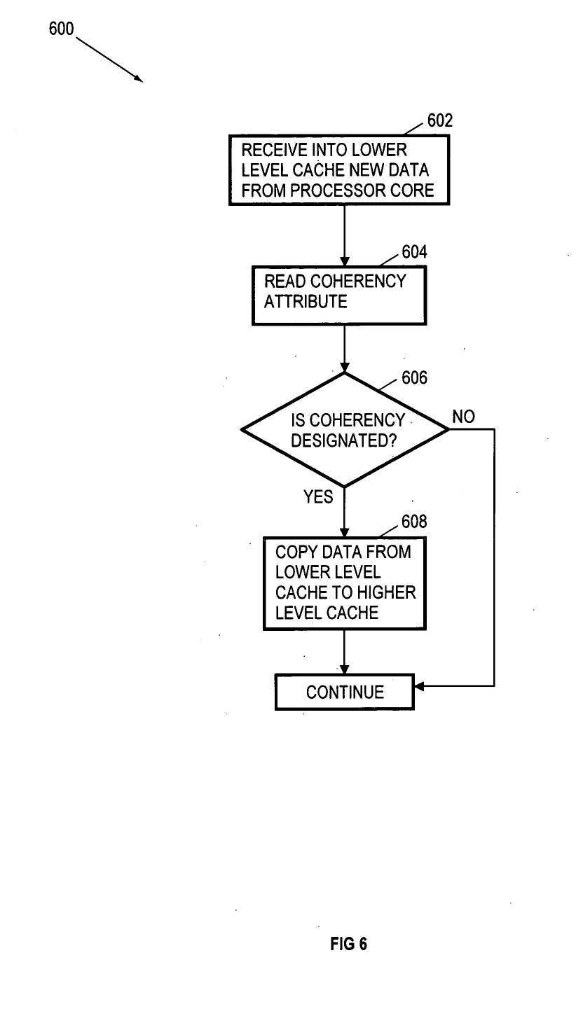

FIG. 6 shows a flow chart 600 of operation of an embodiment for responding to the receipt of data from the processor core by the lower level cache (element 602). In response to receipt of data from the processor core, the system reads the memory coherency attribute of the data (element 604). If coherency is designated (element 606), as determined from the memory coherency attribute, then the system copies the data from the lower level cache to the next higher level of cache (element 608). If coherency is not designated (element 606), the step of copying the data from lower level cache to hire level cache is bypassed.

Although the present invention and some of its advantages have been described in detail for some embodiments, it should be understood that various changes, substitutions and alterations can be made herein without departing from the spirit and scope of the invention as defined by the appended claims. Although an embodiment of the invention may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A multi-level cache system, comprising:
at least a lower level cache memory and a higher level cache memory;
a coherency determiner to determine from a predefined attribute if coherency is designated for an item of data in the lower level cache; and
a cache controller to copy the item of data from the lower level cache to the higher level cache if coherency is designated for the item of data.

2. The system of claim 1, further comprising a validity checker to determine in response to a snoop request whether the data copied to higher level cache for which coherency is designated is held in a modified state.

3. The system of claim 1, further comprising an invalidation controller to invalidate an item of data in the lower level cache in response to an invalidation signal from the higher level cache.

4. The system of claim 2, wherein the invalidation signal from the higher level cache is generated in response to an invalidation signal from a snoop interface.

5. The system of claim 1, wherein the cache controller comprises a write-through controller to determine from an attribute of the data whether the item of data is designated as write-through, and if so, then copying the data from the lower level cache to the higher level cache.

6. The system of claim 5, wherein the write-through attribute is true if the predefined attribute is true.

7. The system of claim 1, wherein in response to a snoop request the system detects whether data is held in modified state in a highest level of cache without determining whether a lower level of cache holds the data in modified state.

8. The system of claim 1, wherein the predefined attribute includes memory coherency

9. A multi-level cache system, comprising:
a plurality of processors, a processor comprising execution units and a lower level of cache and a higher level of cache;
a system memory commonly shared by a plurality of the processors;
a processor local bus comprising circuitry to enable transfer of data between a plurality of the processors and the system memory;
a coherency determiner to determine whether coherency is designated for an item of data stored in the lower level of cache;
a cache control mechanism to copy an item of data from the lower level of cache to the higher level of cache if memory coherency is designated for the item of data and to bypass the step of copying the item of data from the lower level cache to the higher level cache if memory coherency is not designated for the item of data;

10. The system of claim 9, further comprising a validity checking mechanism to determine in response to a snoop request whether requested data is held in a modified state in a highest level of cache.

11. The system of claim 9, further comprising a validation control mechanism to invalidate data in the lower level cache in response to a signal from a control mechanism of the higher level cache.

12. The system of claim 9, further comprising a master interface to facilitate transfer of data between the system memory and a plurality of processors.

13. The system of claim 9, wherein the processor local bus comprises a snoop interface to broadcast a snoop request to a plurality of snoopable processors.

14. The system of claim 9, wherein the cache control mechanism comprises circuitry to invalidate data in the lower level cache in response to an invalidation of the data copied into the higher level cache.

15. The system of claim 9, wherein the cache control mechanism responds to a snoop request for an item of data by determining if the requested item of data is held in a modified state in a highest level of cache without determining if the data is in a lower level cache.

16. The system of claim 9, wherein the cache control mechanism is adapted to invalidate data in the lower level cache in response to an invalidation signal from a control mechanism of the higher level cache.

17. A method for allocating memory in a multi-level-cache system, comprising:
determining from a user-specified attribute associated with an item of data in a first, lower level of cache that memory coherency is designated for the item of data;
copying the item of data from the first cache to a second, higher level of cache if memory coherency is designated for the item of data; and
bypassing a step of copying the item of data from the first cache to the second cache if memory coherency is not designated for the item of data.

18. The method of claim 16, further comprising:
detecting a condition wherein the item of data copied to the higher level cache is invalid; and
invalidating the item of data in the first, lower level of cache; in response to the detected condition.

19. The method of claim 17, further comprising detecting a snoop request and limiting the snoop request to a request for modified data from the higher level of cache without snooping the lower level of cache.

20. The method of claim 16, further comprising inspecting a highest level of cache in a hierarchy of cache in response to a snoop request for the item of data for which memory coherency is designated but omitting a step of inspecting a lower level of cache in response to the snoop request.

21. The method of claim 16, further comprising invalidating data in the lower level cache if the copied data in the higher level cache is invalidated.
